(19) United States
(12) Patent Application Publication
(10) Pub. No.: US 2010/0070352 A1
(43) Pub. Date: Mar. 18, 2010

(54) Consumer incentive system and method

(76) Inventor: William Flanders, Merrimack, NH (US)

Correspondence Address: MESMER & DELEAULT, PLLC, 41 BROOK STREET, MANCHESTER, NH, 03104, US

(21) Appl. No.: 12/560,644

(22) Filed: Sep. 16, 2009

Related U.S. Application Data
(60) Provisional application No. 61/097,238, filed on Sep. 16, 2008.

(51) Int. Cl. G06Q 30/00; G06Q 40/00

(52) U.S. Cl. 705/14.1; 705/37

(57) ABSTRACT

A method and system to enhance the relationship between a manufacturer and a consumer includes offering the consumer who is purchasing at least one of a product of the manufacturer an opportunity to invest in and profit from the future success of the manufacturer in exchange for all or a part of a manufacturer's incentive for purchasing the at least one product.

This application claims the benefit of U.S. Provisional Patent Application No. 61/097,238, filed Sep. 16, 2008.

### BACKGROUND OF THE INVENTION

1. Field of the Invention

The present invention relates generally to marketing and sales of products. Particularly, the present invention relates to incentive programs for marketing and sales of consumer oriented goods.

2. Description of the Prior Art

It is well known that the American consumer is a powerful and influential force in the marketplace. The individual American consumer not only controls their personal purchase power but can be highly influential in the buying decisions of others such as family, friends, co-workers, and the like. Companies and/or manufacturers constantly compete for the attention and loyalty of the American consumer to support company goals and objectives. Most companies and/or manufacturers reach out to the American consumer by way of products, services, purchase incentives, etc., all being variations of common themes.

Manufacturers of consumer oriented goods include, but are not limited to, automobiles, motorcycles, boats, RV's, power sport vehicles, high end electronics and appliances. The traditional relationship between the manufacturer and consumer is one of a transaction based buyer/seller. Consumer buying criteria is often based on price, feature/benefits, brand loyalty, discounts, terms, etc.

Many different types of sales incentive programs are known to those skilled in the art, including for example, incentive programs relating to financing, cash-back to the customer and various free maintenance and extended warranty programs.

In a typical incentive financing program, a manufacturer may offer a combination of interest rates and payment schedules that are generally more favorable than those available through conventional financing. In a cash-back incentive program, a manufacturer may offer a predetermined sum of cash back to a buyer, the cash being available to the buyer to either lower the purchase price of the item or to simply take and use for other purposes. Such programs are offered to customers through local dealers, with the costs, and in many cases the implementation and processing, being subsidized by the manufacturer.

In a typical extended warranty program, a dealer offers the extended warranty in accordance with terms set by the manufacturer, with dealer maintenance costs being reimbursed by the manufacturer.

Competition among manufacturers of consumer oriented goods is keen and companies have particular difficulty in winning and maintaining the loyalty of customers. In response, manufacturers have implemented reward-based programs to provide incentives to customers to continue to do business with the manufacturer. Examples of these reward-based programs include airline and credit card point reward programs and vehicle customer loyalty discounts. The “frequent flyer” programs available at most airlines require the customer to join the program by entering personal and demographic information on an application form. The customer is typically credited with mileage points corresponding to the number of air miles flown with the airline. When sufficient points have been accumulated, the frequent flyer member is eligible to redeem those points for awards such as passenger service class upgrades and discounted or free airline tickets. Credit card point reward programs include not only airline tickets but also non-travel related products and services.

While these programs encourage repeat customer business, the programs do little to foster growth of the customer base beyond an incentive to obtain the discounts and benefits offered.

Therefore, what is needed is a method of generating and increasing the sales and new customer base of a business. What is also needed is a method of retaining existing customers.

### SUMMARY OF THE INVENTION

It is an object of the present invention to provide a method of generating and increasing sales and new customer base of a business. It is another object of the present invention to provide a method of retaining existing customers. It is a further object of the present invention to provide another dimension to the relationship between manufacturer and customer.

The present invention achieves these and other objectives by providing a method to enhance the relationship between a manufacturer and a consumer where the consumer who is purchasing at least one of a product of the manufacturer is offered an opportunity to invest in and profit from the future success of the manufacturer in exchange for all or a part of a manufacturer's incentive for purchasing the at least one product. This new method transcends the traditional buyer/seller relationship, which is a transaction-based event where the buying decision is based on product price, features, benefits, performance, styling, etc. The present invention supports a manufacturer's desire to differentiate itself from other manufacturers (i.e. competitors) by engaging the customer/consumer in a higher level, more comprehensive, business partnership. The present invention provides a business method for manufacturers where the relationship between the manufacturer and the consumer is redefined and elevated from a customer buying a product to a business partner with mutual interests in improving future financial performance of the manufacturer. In this new business model, the initial purchase of the manufacturer's product, by the consumer, is the basis for a larger, broader business relationship of the two parties. In this business model, the purchase transaction is expanded to include one or more mechanisms in which the consumer benefits financially as the future performance of the company improves. Types of financial metrics may include, but are not limited to, annual sales revenue, stock value, units sold, etc.

By sharing in future success of the manufacturer, the consumer is incentivized to purchase manufacturer's product, provide input to manufacturer in improving products and services along with promoting manufacturer's products and business model to other consumers. All of this is in an effort to improve manufacturer's future financial performance. The manufacturer benefits by having a multitude of stakeholders actively engaged in helping the company improve future financial performance.

One embodiment of the present invention is a method of improving consumer loyalty and promoting consumer incentive. The method includes enrolling a consumer of a manufacturer's product in a stakeholder program, issuing a predefined number of value units to the consumer at the time of purchase of the manufacturer's product, initiating a value cycle based on a predefined time period for the predefined number of value units based on a quantitative measure of the manufacturer's product, completing the value cycle time period, and computing the final value of the predefined number of value units based on the performance of the manufacturer during the value cycle.

In another embodiment of the present invention, the step of issuing value units to the consumer includes the consumer selecting a quantity of value units to be issued.

In a further embodiment of the present invention, the step of initiating a value cycle includes selecting the quantitative measure to be used in the stakeholder program.

In another embodiment of the present invention, the method further includes redeeming the value units of the stakeholder program.

In another embodiment of the present invention, the computing step includes a minimum final value and selecting the greater of the final computed value or the minimum final value.

Another embodiment of the present invention is a method operable on a computer to provide a plurality of customers participating in a manufacturer incentive loyalty stakeholder program relating to purchases of predefined manufacturer's product. The method includes receiving a customer identification number associated with each customer, receiving customer information from each customer including a number of customer incentive units allocated to each customer, selecting a program measurement index related to the predefined manufacturer's product, determining an initial measurement index value, storing the customer information with each respective customer identification number on the computer, and determining a current value of the customer incentive units after a predefined time cycle wherein the current value is based on the performance of the manufacturer as determined by the difference between current measurement index value and the initial measurement index value.

In another embodiment of the present invention, the method further includes providing access to a customer enrolled in the stakeholder program to that customer's record for the customer's personal review.

In a further embodiment of the present invention, the method further includes providing access to a dealer for the manufacturer's product to the dealer's customers records enrolled in the manufacturer's stakeholder program.

In still another embodiment of the present invention, the method further includes periodically updating the customer measurement index value, calculating an updated customer incentive value and storing the updated customer incentive value.

Another embodiment of the present invention includes a system for providing a plurality of customers participating in a manufacturer incentive loyalty stakeholder program relating to purchases of a predefined manufacturer's product. The system includes a computer processor and a memory operatively connected to the processor where the processor is operative with control instructions in the memory to perform predefined operational steps. The steps include receiving a customer identification number associated with each customer, receiving customer information from each customer including a number of customer incentive units allocated to each customer, selecting a program measurement index related to the predefined manufacturer's product, determining an initial measurement index value, storing the customer information with each respective customer identification number on the computer, and determining a current value of the customer incentive units after a predefined time cycle wherein the current value is based on the performance of the manufacturer as determined by the difference between current measurement index value and the initial measurement index value.

In another embodiment of the present invention, the measurement index used in the system is based on the group selected from a manufacturer's product market share, a quantity of manufacturer's product sold during the program, annual sales revenue, stock value, and a quantity of manufacturer's product sold during the program in a particular geographic market.

In a further embodiment of the present invention, the control instructions in the memory of the system further performs the step of selecting between a current customer incentive value and a minimum incentive value at time of customer redemption.

### BRIEF DESCRIPTION OF THE DRAWINGS

FIG. 1 is a block diagram illustrating a system for administering an incentive program in accordance with the present invention.

FIG. 2 is an illustration of one embodiment of the process flow of the present invention.

FIG. 3 is a flow chart illustrating a process by which manufacturer or dealer may initiate a partnership incentive program.

FIG. 4 is a flow chart illustrating a process by which an incentive program customer record is updated and by which a customer and/or a dealer of the manufacturer may access the records of incentive program.

FIG. 5 is a table illustrating an exemplary customer incentive database record as may be stored in the customer incentive database of FIG. 1.

FIG. 6 is a table illustrating an exemplary consumer goods and sales database record as maybe stored in the customer incentive database of FIG. 1.

### DETAILED DESCRIPTION OF THE PREFERRED EMBODIMENT

### Definitions

It will be understood that the use of the terms “sale” and “purchase”, or variants thereof, as used interchangeably throughout this document to mean sales and/or leasing of goods to buyers.

It will be understood that the term “program price” and variants thereof are used interchangeably throughout this document to indicate a price for the purchase of a redeemable “ownership” interest in the manufacturer by a consumer pursuant to the incentive program of the present invention.

System.

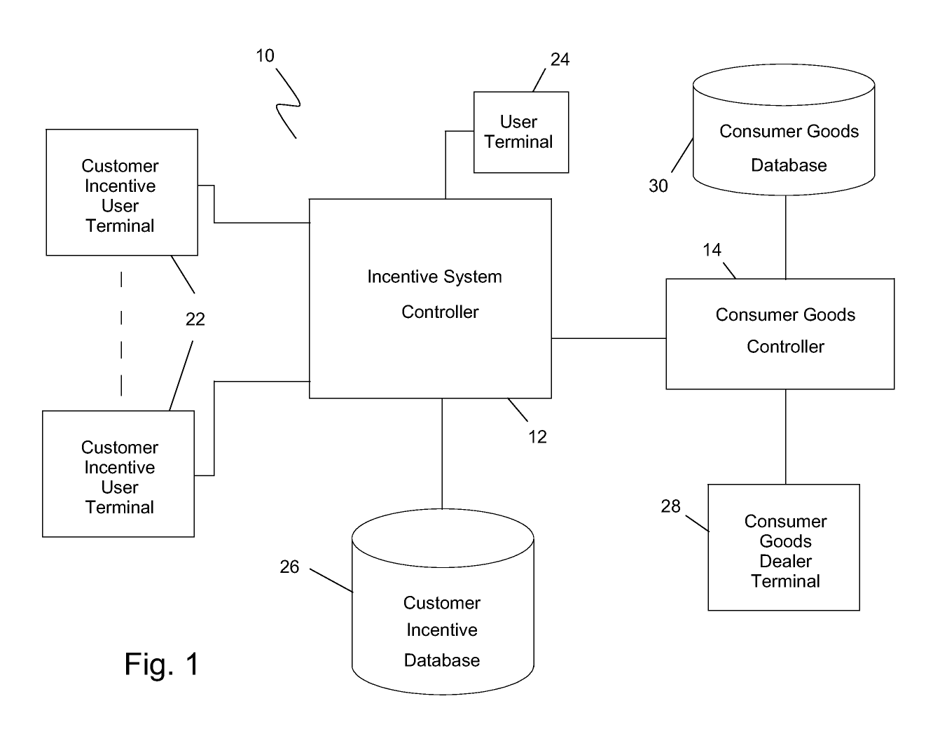

With reference now to FIG. 1, there is shown a computer system 10 including an incentive system controller 12 which is connected to a consumer goods sales controller 14. Each of the controllers 12 and 14 comprises a conventional computer with an operating system of a type well known in the art. As will be described in further detail below, controllers 12 and 14 are typically geographically separate, with illustrated communications links comprising networking connections, many types of which are well known to those skilled in the art. Controllers 12 and 14 are connected so as to facilitate the exchange of data in a manner described in detail below.

Incentive system controller 12 is seen to support one or more local user terminals 24 for entering data, software and control information into the controller. Controller 12 further supports a customer incentive database 26 for storing customer incentive information as described in further detail below. Controller 12 also supports a plurality of customer user terminals 22 to allow customers enrolled in the incentive loyalty program access to their personal records in the customer incentive database 26, as described in further detail below. In a similar manner, consumer goods sales controller 14, connected to incentive system controller 12 as described above, supports both a local terminal 28 and a consumer goods sales database 30.

It will be understood that, with the exception of the data contents and control instructions as described herein, databases 26 and 30 comprise conventional storage facilities, for example appropriate combinations of semiconductor, magnetic and optical storage medium. Terminals 24 and 28 likewise comprise conventional computer terminals, for example including displays, keyboards and related data entry devices as well as wireless communications devices that use wireless communications for connecting to the Internet that allows sending, receiving and viewing data, both secured and unsecured. It should be understood that the term “terminal” does signify any particular means of or structure used for inputing and/or accessing data in the database but broadly includes any and all means for accomplishing such a function.

With respect to the parties associated with the practice of the present invention, the consumer goods sales controller 30 may be operated by the consumer goods manufacturer with terminals distributed at local dealers or may be operated at the location of an individual goods manufacturer dealer. The incentive program itself is preferably sponsored by a consumer goods manufacturer who supplies the consumer goods dealer. The operation of the incentive system controller to support the program may be by the consumer goods manufacturer or by a third party, for example an investment bank, an investment broker, another financial institution or others having the capability to operate such a system.

Data Records.

There will now be described exemplary data fields for facilitating the system operation described further below.

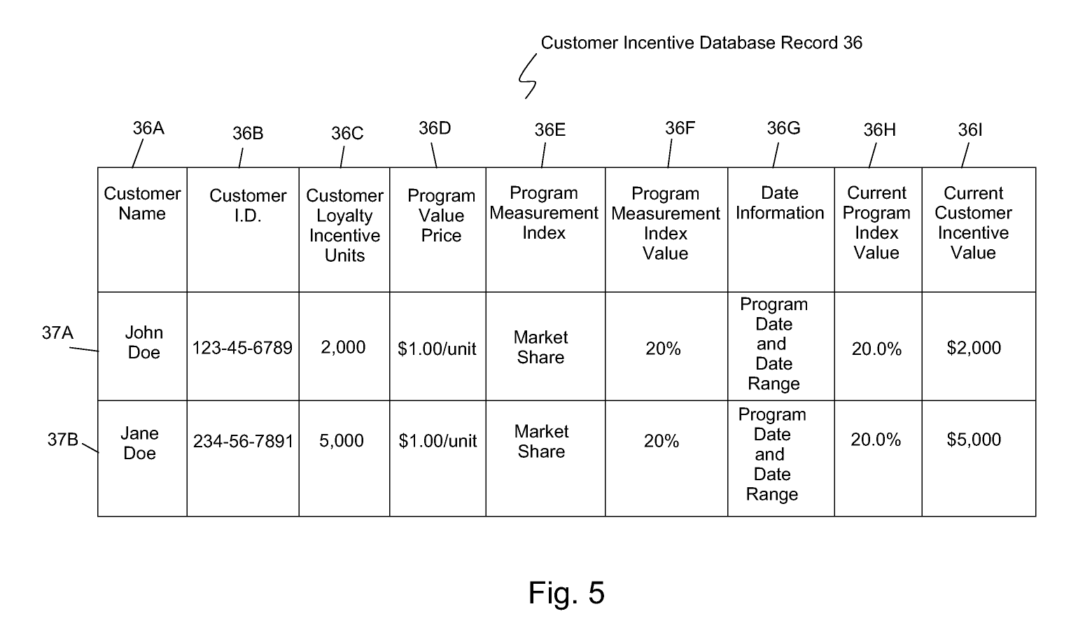

With reference now to FIG. 5, there is shown an exemplary customer incentive database record 36 from customer incentive database 26 including two data entries 37A-B, each entry including six data fields 36A-F. Data fields 36A and B store a customer name and unique identification number or equivalent account identifier), respectively. Fields 36C and D describe the quantity of customer loyalty incentive units and the incentive program price value per unit that are covered under the incentive program for a particular, enrolled customer. Data field 36E indicates the incentive program index used to calculate the increase in value of the enrolled customer's incentive value during the incentive program date range. In this example, it is the goods manufacturer's market share. Data field 36F shows the incentive program measurement index value on the date a customer is enrolled into the incentive program. Continuing with the present example, it is represented by the manufacturer's market share for the particular goods in the incentive program. In this case, the goods manufacturer has a 20% market share for the particular goods. A field 36G indicates the date range of the program, shown here as including the purchase date of the particular goods and the length of the program following the purchase date. Data field 36H shows the current incentive program index value and date while data field 36I shows the current customer incentive value in preferably dollars. Upon initial enrollment of a customer, the program measurement value index and the current program index value are the same. The data in fields 36H and 361 may be particularly useful to both the dealer and the manufacturer for devising new sales and marketing events and may represent unique marketing opportunities for directed marketing and advertising to particular customers.

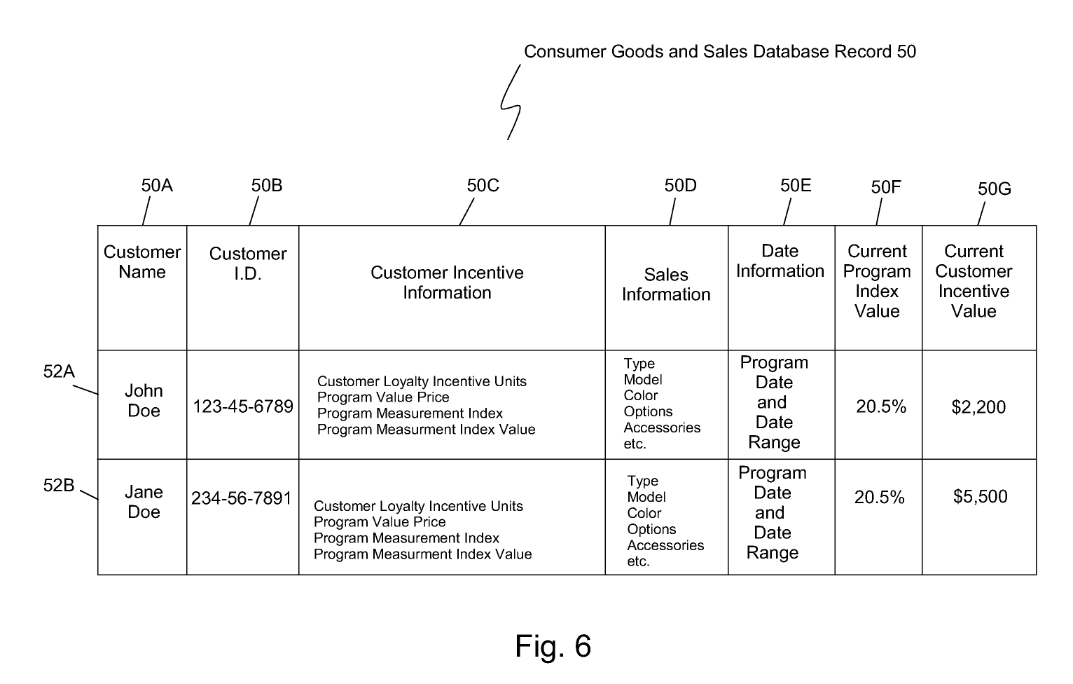

Turning now to FIG. 6, an exemplary consumer goods dealer sales database record 50 is shown as may be stored in consumer goods dealer sales database 30. Record 50 contains two entries 52A and 52B, each of which includes nine or more fields. Data field 50A includes a customer name, while data field 50B includes personal customer information relating to a consumer goods sale, including for purposes of this invention a customer identification number (or other account identifier). Field 50B or other fields may further include numerous additional data as maybe relevant to the consumer goods dealer and manufacturer, for example customer address, demographics, etc., or separated into additional fields. A data field 50C includes customer incentive information, including the quantity of consumer incentive units and program price of each incentive unit purchased. A field 50D includes incentive program date information such as a purchase date and program length. A field 50E includes other sales information, which may be of interest or use to a dealer or manufacturer, for example the type, model and color of the goods purchased and any options elected by the customer/consumer. Data field 50F shows the current incentive program index value and date while data field 50G shows the current customer incentive value in preferably dollars. The data in fields 50F and 50G may be particularly useful to both the dealer and the manufacturer for devising new sales and marketing events, initiatives, programs, and the like, and may represent unique marketing opportunities for directed advertising to particular customers. In addition, each customer enrolled in the customer loyalty incentive program would have secure access to his or her own customer record information in the customer incentive database 26 including the information in the current incentive program index value and current customer incentive value. This would provide the customer with a means for tracking the growth of the customer's loyalty incentive value to determine when and/or if the customer should “cash in” or redeem the incentive units.

It will be understood that the data records as described herein are exemplary of the present invention and numerous other configurations as well as data storage arrangements will now be apparent to those skilled in the art.

Operation of the System.

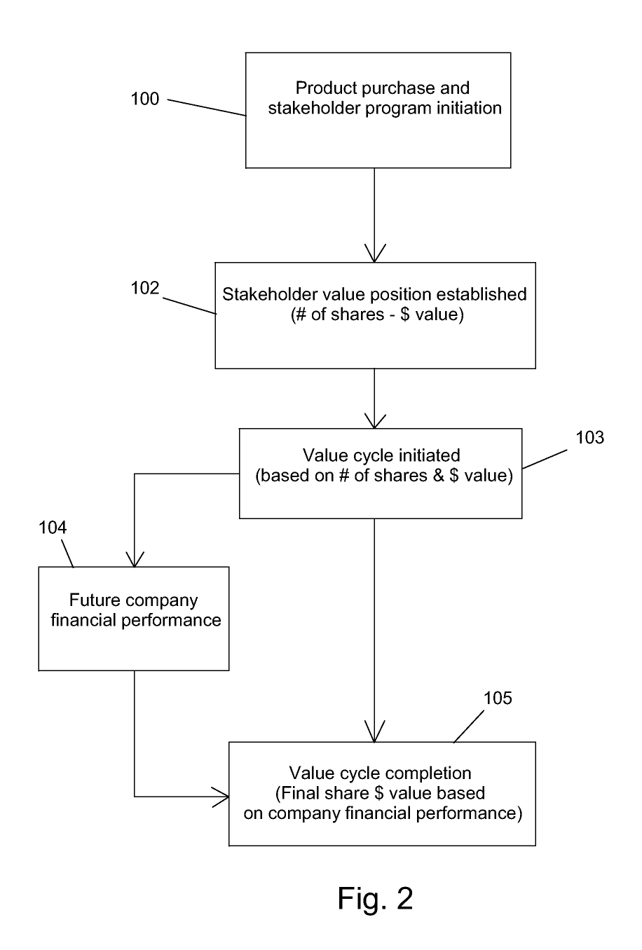

The various processes associated with the operation of the system will now be described with respect to FIGS. 2, 3, and 4.

One example of this model/method is illustrated by FIG. 2. At the time of consumer goods purchase, the consumer is offered the option of joining the company's customer loyalty incentive/stakeholder program at Step 100. The consumer chooses to participate in the program. In lieu of or in combination with other incentives, the customer at Step 102 is awarded a certain amount of “points” or “loyalty incentive units”, each with the value of one US dollar. At Step 103, the value cycle for measuring the company's future financial performance indicated at Step 104 is initiated. At step 105, the value cycle is completed and the final customer loyalty incentive value is determined based on the financial performance of the company during the value cycle period. The value cycle period may be any desired time period and the program may also include multiple value cycle periods.

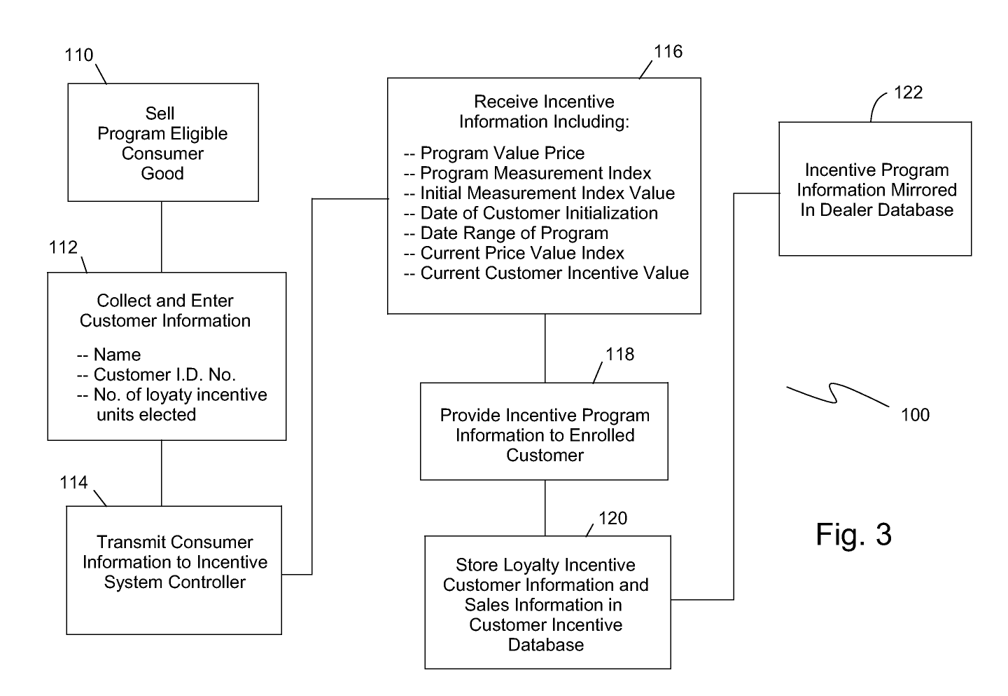

With reference first to FIG. 3, a process 100 is shown for establishing the customer loyalty incentive program of the subject invention incident to the sale of a consumer product such as a vehicle.

Incident to the sale of a consumer product such as an automobile by an automobile dealer (step 110), the dealer collects customer information relating to the buyer and enters the same into consumer goods controller 14 (step 112). Such customer information includes data relative to the customer's name, unique customer identification number (which may be the customer's social security number or one generated by the computer, and the number of loyalty incentive units allocated to the customer.

Subsequent to the collection of the information, all relevant information necessary to the calculation of a program incentive unit price and total number of incentive units allocated/“purchased” by the customer (the calculation process being described below) is transmitted from consumer goods sales controller 14 to incentive system controller 12 (step 114). The incentive system controller is used to calculate a program price and other information and parameters pertinent to the incentive program and the incentive program information is transmitted back to and received by consumer goods sales controller 14 from incentive system controller 12 (step 116). The incentive system controller 12, in a manner described below, stores a copy of the incentive program data in customer incentive database 26. Subsequently, a copy of the incentive program information, along with directions for its use, is provided to the customer (step 118). A permanent copy of the incentive program information is stored in consumer goods sales database record 36 for future use by the automobile dealer and/or the automobile manufacturer (steps 120 and 122).

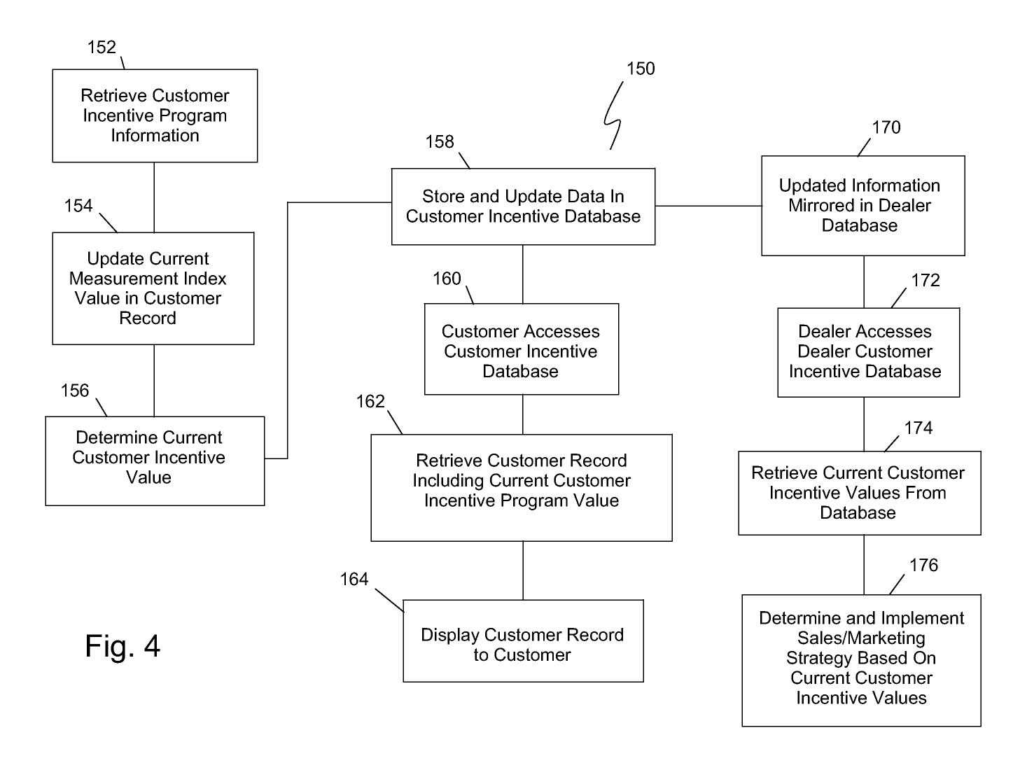

With reference now to FIG. 4, there is shown a process 150 for applying the customer loyalty incentive. Periodically, and preferably automatically, the software program retrieves customer incentive program information (Step 152). The current measurement index value is updated in the customer incentive record (Step 154). This update may be entered into the system by the manufacturer or may be automatically updated by way of a networked communication with the finance department of the manufacturer or the data may be automatically sent by the manufacturer to the customer incentive controller 12. Regardless of the procedure for updating the current measurement index value, the program determines the current customer incentive value based on the current measurement index value and on the number of customer incentive units allocated and stored in the customer incentive record (Step 156). The new calculated data is stored and updated in the customer incentive database 26 (Step 158). The updated information in the customer incentive database 26 is mirrored in the dealer consumer goods sales database 30 (Step 170). Both the customer and the dealer have access to the information in the databases.

In this embodiment and relating to customer access, the customer accesses the customer's personal and secured data record (for example reference number 36A in FIG. 5) stored in the customer incentive database 26 using any type of customer user terminal that is electronically connected through a network and has the capability of electronically accessing the database (Step 160). Subsequent to the customer accessing the customer incentive database 26, the customer record is retrieved including the current customer incentive program value (Step 162). The customer record is displayed on the customer user terminal to the customer (Step 164). The customer is not limited in the number of times that the customer may access customer's personal information. In the dealer access model, the dealer accesses the dealer customer goods and sales database 30 (Step 172). Subsequent to the dealer accessing the dealer customer goods and sales database 30, the customer record or records are retrieved from database 30 based on dealer-selected criteria and displayed to the dealer (Step 174). From the displayed customer incentive data, the dealer may devise and implement a sales and marketing strategy based on the current customer incentive values (Step 176).

In a first embodiment of the invention, the customer may trade all or a portion of the rebate incentives being offered for the loyalty incentive units. In another embodiment, the amount of the rebate incentives capable of being traded by the customer may be determined by the provider of the incentive program. Similarly, in one embodiment of the invention the customer may indicate a choice from a selection of offered program measurement value indices to be used in determining incentive value growth during the program period. In an alternate embodiment of the invention, the program operator predetermines the incentive measurement value index to be used under the incentive program. This information (the number of incentive units, program value price, program measurement index and program measurement index value) is stored in the customer incentive fields 36C-36F, respectively, of customer incentive database record 36 (FIG. 5).

The following specific, illustrative example of the present invention involves automobile manufacturers selling into the United States. The US is a highly competitive market with several manufactures vying for consumer sales. The relationship between the automotive manufacturer and the consumer is product transaction based. Automobile manufacturers use traditional methods to sell autos; price discounts, terms, warrantees, features/benefits, brand loyalty, performance, reliability, etc.

An automotive manufacturer implementing the method of the present invention would have the opportunity to transcend the traditional buyer/seller relationship with the consumer to that of a business partner/stakeholder with mutual interests and an incentive to improve the company's future financial performance. Both parties share in the monetary rewards of future improvements in the company's financial performance.

In the automobile vehicle case, for example, the metric for the company's future financial performance may be the increase in the number of vehicles sold into the USA, on a year to year basis. If for example, the company sold 15% more vehicles into USA next year, over this year, the value of the “points” or “phantom stock shares” would increase by 15%.

A more specific and illustrative example of a vehicle manufacturer incentive program is outlined below.

### Example 1

An American based automobile company has been losing US market share to foreign-owned OEM's (i.e. original equipment manufacturers) for the past several years due to poor reliability, lower gas mileage, etc. The American manufacturer has made product improvements to the point where the manufacturer's product is on par with foreign-owned OEM's. The American manufacturer needs to accelerate the recapture of US market share beyond normal attrition. The American auto manufacturer initiates an “Active Owners Program” to help re-energize American consumer loyalty to the manufacturer's American made automobiles. The program is designed to strengthen the bond between the American consumer and American automobile manufacturer.

At the time of vehicle purchase (or some predetermined time after purchase), the buyer is given the option to “invest” in the success of the company. In this case, the company is offering $5,000.00 in incentive discounts. In lieu of taking these discounts, the buyer can opt to receive $5,000.00 (or some percentage of the total incentive) in customer incentive units (i.e. phantom shares) of the manufacturer offered through the manufacturer's customer loyalty and incentive program. Each unit/share has a dollar value, in this case $1.00. The buyer now has 5,000 customer loyalty incentive units or phantom shares. In this example, the program is set up to measure success against the manufacturer's market share in US. The manufacturer's current market share is 20%. The buyer has the option of holding the customer loyalty incentive units or phantom shares for up to 36 months but must hold them for a minimum 12 months. For every 1% increase in the manufacturer's US market share, the value of each customer loyalty incentive unit or phantom share increases 20%. The value measurement is based on year to year, quarter to quarter growth in market share. The customer may optionally be guaranteed a minimum 3% annual return on the customer loyalty incentive unit or phantom share regardless of market share shift. The customer has the option to redeem the customer loyalty incentive units or phantom shares at any quarter period after 12 months and on or before 36 months. Redemption can be in the form of cash or credit towards a new vehicle purchase.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A method to enhance the relationship between a manufacturer and a consumer comprising offering the consumer who is purchasing at least one of a product of the manufacturer an opportunity to invest in and profit from the future success of the manufacturer in exchange for all or a part of a manufacturer's incentive for purchasing the at least one product.

2. The method of claim 1 further comprising:
enrolling a consumer of a manufacturer's product in a stakeholder program;
issuing a predefined number of value units to the consumer at the time of purchase of the manufacturer's product;
initiating a value cycle based on a predefined time period for the predefined number of value units based on a quantitative measure of the manufacturer's product;
completing the value cycle time period; and
computing the final value of the predefined number of value units based on the performance of the manufacturer during the value cycle.

3. The method of claim 2 wherein the step of issuing value units to the consumer includes the consumer selecting a quantity of value units to be issued.

4. The method of claim 2 wherein the step of initiating a value cycle includes selecting the quantitative measure to be used in the stakeholder program.

5. The method of claim 2 further comprising redeeming the value units of the stakeholder program.

6. The method of claim 2 wherein the computing step includes a minimum final value and selecting the greater of the final computed value or the minimum final value.

7. A method operable on a computer to provide a plurality of customers participating in a manufacturer incentive loyalty stakeholder program relating to purchases of predefined manufacturer's product, the method comprising:
receiving a customer identification number associated with each customer;
receiving customer information from each customer including a number of customer incentive units allocated to each customer;
selecting a program measurement index related to the predefined manufacturer's product;
determining an initial measurement index value;
storing the customer information with each respective customer identification number on the computer; and
determining a current value of the customer incentive units after a predefined time cycle wherein the current value is based on the performance of the manufacturer as determined by the difference between current measurement index value and the initial measurement index value.

8. The method of claim 7 further comprising providing access to a customer enrolled in the stakeholder program to that customer's record for the customer's personal review.

9. The method of claim 7 further comprising providing access to a dealer for the manufacturer's product to the dealer's customers records enrolled in the manufacturer's stakeholder program.

10. The method of claim 7 further comprising periodically updating the customer measurement index value, calculating an updated customer incentive value and storing the updated customer incentive value.

11. A system for providing a plurality of customers participating in a manufacturer incentive loyalty stakeholder program relating to purchases of a predefined manufacturer's product, the system comprising:
a computer processor; and
a memory operatively connected to the processor wherein the processor is operative with control instructions in the memory to perform the steps of:
receiving a customer identification number associated with each customer;
receiving customer information from each customer including a number of customer incentive units allocated to each customer;
selecting a program measurement index related to the predefined manufacturer's product;
determining an initial measurement index value;
storing the customer information with each respective customer identification number on the computer; and
determining a current value of the customer incentive units after a predefined time cycle wherein the current value is based on the performance of the manufacturer as determined by the difference between current measurement index value and the initial measurement index value.

12. The system of claim 11 wherein the measurement index is based on the group selected from a manufacturer's product market share, a quantity of manufacturer's product sold during the program, annual sales revenue, stock value, and a quantity of manufacturer's product sold during the program in a particular geographic market.

13. The system of claim 11 wherein the control instructions in the memory further performs the step of selecting between a current customer incentive value and a minimum incentive value at time of customer redemption.
